(19) United States
(12) Patent Application Publication
(10) Pub. No.: US 2007/0250836 A1
(43) Pub. Date: Oct. 25, 2007

(54) Method for expanding data flow

(75) Inventors: Sheng Li, Tianjin (CN); Tom Chen, Taipei (TW); Win-Harn Liu, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/408,949

(22) Filed: Apr. 24, 2006

(51) Int. Cl. G06F 9/46

(52) U.S. Cl. 718/105

(57) ABSTRACT

A method for expanding data flow applied in a network system comprising at least one client, at least two load balancers and at least one server. A first load balancer can automatically confirms whether it is overloaded or not and edit a hash table accordingly, so as to activate a second load balancer, thereby improving the processing capacity of the load balancer and keeping the clients from waiting for a long time due to the influence of the load balancer.

### BACKGROUND OF THE INVENTION

1. Field of Invention

The present invention relates to a method for expanding data flow, and more particularly to a method for expanding data flow with a first load balancer activating a second load balancer according to the load condition thereof.

2. Related Art

Nowadays, some relative large-scale websites may deal with millions of user requests everyday with the popularization of networks. However, it may be impossible for a single machine to process such a great amount of requests according to its load capacity. The simplest consideration to this problem is to enhance the hardware performance of the machine. However, such an idea is not economical. Besides, all the services provided by the whole website will completely come to a stop if something wrong occurs to the single machine. So another possibility is to use a number of machines to share the processing of these requests while one machine is used for load balancing and acts as a window for communication with the outside. When the user sends his or her request, he or she faces such a super large-scale server, yet, in fact, it is a cluster that deals with such requests. In this way, the processing capacity may be actually improved in a relatively economical level without considering using a work station level server as the dominant server hardware.

For example, when a request for a virtual server is sent to the load balancer, the load balancer will firstly check if the packet has a particular linkage port of the corresponding virtual server (recorded in the virtual service list). If so, then it will check how many connections are in the internal cluster and the connection condition of each machine. Through a special scheduled algorithm, the load balancer selects the real server most proper to accept such a connection, forward such a connection request to the real server and enable it to deal with this request and make a response. When the server has sent the packet for response, the load balancer will process the packet and modify the real IP of the internal server (belonging to the private IP) into the real external IP of the virtual server. After that, when the time for connection is ended, this connection will be removed from the virtual service list. Thus, for the user, he or she only communicates with the load balancer, i.e. the virtual server, for the request.

In the conventional network system, a primary load balancer is used for processing the data of the clients, while a secondary load balancer is used for data backup. Only when the primary load balancer fails, will the secondary load balancer take over the task of the primary balancer, so that the clients will not feel interrupted. The advantage of the primary load balancer is that the server may operate any operating system supporting TCP/IP and it needs only one IP address to be allocated to the load balancers while the server group may use the private IP addresses. The disadvantage of the primary load balancer is its limited load capacity, and what's more, both the request and the response packets in the network have to pass through the primary load balancer, consequently, when the primary load balancer is overloaded, the clients will be kept waiting for a long time. Further, the expansibility of the primary load balancer is limited, so the primary load balancer itself is likely to be a new bottleneck of the system.

### SUMMARY OF THE INVENTION

In view of above-mentioned problems, the major object of the present invention is to provide a method for having a backup and expanding data flow, so as to solve the problems in the prior art.

To achieve the above-mentioned object, the method for expanding data flow disclosed in the present invention is applied in the network system comprising at least one client, at least two load balancers and at least one server, comprising the following steps: the first load balancer creates a determine value and a master code; the server carries out the three party handshake with each of the clients through the first load balancer; each of the clients transmits the connection request to the first load balancer; the first load balancer calculates the number of the received connection requests; the first load balancer confirms that the number of the connection requests is not smaller than the determine value; the first load balancer edits the hash table with the master code, so as to add the second load balancer; the first load balancer and the second load balancer receive the connection requests; the first load balancer and the second load balancer forward each of the connection requests to the server; and each of the clients carries out data access to the server.

The present invention is characterized in that the first load balancer can automatically confirm whether it is overloaded or not to edit the hash table, so as to activate the second load balancer and forward rapidly the requests of the clients to the server, thereby increasing the processing capacity of the load balancer.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a block diagram of the embodiment disclosed according to the present invention; and

FIG. 2 is a flow chart of the method for expanding data flow disclosed according to the present invention.

### DETAILED DESCRIPTION OF THE INVENTION

The number of clients and network flow increase in geometric progression, which leads to a great demand for the flexibility of the network service. Since the number of times when a website is connected increases sharply and thus the website cannot deal with the clients' requests in time, the clients will be kept waiting for a long time. Accordingly, the overload of the load balancer can be solved according to the present invention.

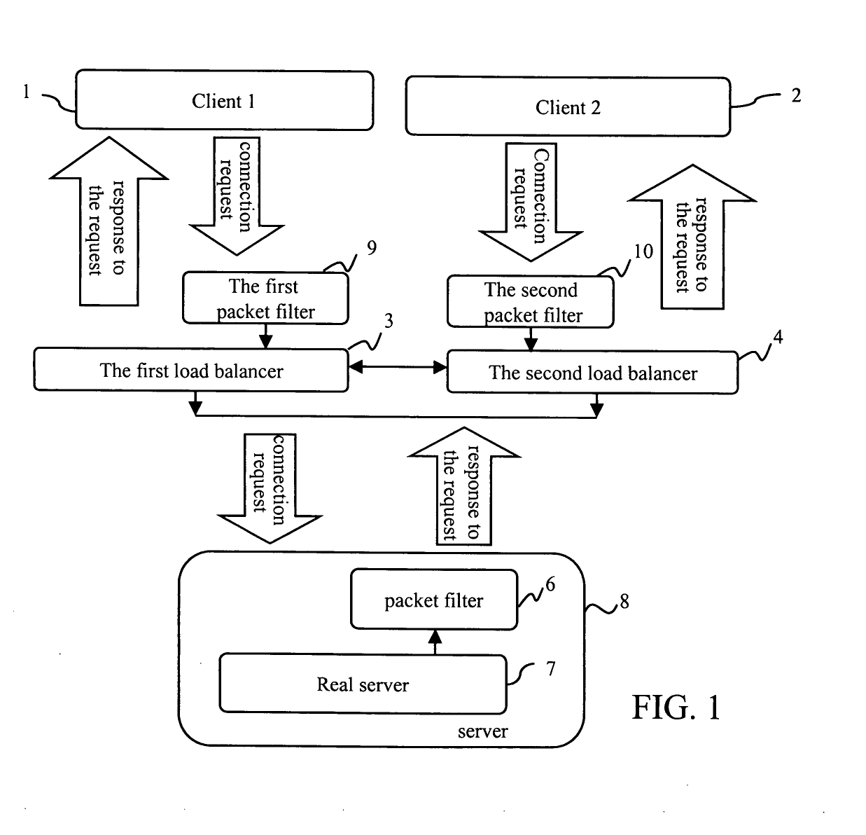

With reference to FIG. 1, it illustrates an embodiment disclosed according to the present invention. The embodiment taking two load balancers for example is applied in a network system comprising at least one clients 1, 2, a first load balancer 3, a second load balancer 4, at least one server 8, a first packet filter 9 and a second packet filter 10, in which the server 8 comprises a real server 7 and a packet filter 6. The first load balancer 3 automatically determines whether it is overloaded or not through the number of requests received by the first packet filter 9 to activate the second load balancer 4, so as to directly forward the requests of the clients 1 and 2 to the server 8. Therefore, the clients 1 and 2 will not be influenced by the overload of the first load balancer 3 and wait for a long time. When the first load balancer 3 is determined to be overloaded, the first load balancer 3 sets the IP address and the physical address of the network card of the second load balancer 4 to be the same with those of the first load balancer 3 through the hash table, so that both of the first load balancer 3 and the second load balancer 4 will directly forward the requests of the clients to the selected server 8.

Here, both of the first load balancer 3 and the second load balancer 4 may receive the requests from the plurality of clients 1 and 2 through the first packet filter 9 and the second packet filter 10. The first load balancer 3 and the second load balancer 4 may directly forward the received requests to the selected server 8. The process will continue until the requests of the clients 1 and 2 no longer exceed the first load balancer 3. Then the hash table is edited again, meaning the IP address and the physical address of the network card of the second load balancer are changed back to original, and thus only the first load balancer 3 is allowed to receive the requests of the clients through the first packet filter 9 and directly forward them to the selected server 8 while the second load balancer 4 performs the action of data backup. In the first load balancer 3 are stored a master code and the hash table in which is stored a hash algorithm. The received requests are distributed into the load balancer 3 and 4 through the hash algorithm so as to be forwarded to the corresponding server 8.

The clients 1 and 2 are user interfaces which may send out requests and various corresponding packets according to the requirement of the users and receive the data or packets from the server 8. The first load balancer 3 views the content of the requests of the users through the first packet filter 9 and is responsible for directly forwarding the requests of the clients 1 and 2 to the selected server 8 for execution. The server 8 actually executes the requests of the clients 1 and 2 and the request service executed by the server 8 includes WEB, FTP, DNS and the like. When the server 8 executes the requests of the clients 1 and 2, it has to directly forward them to the real server 7 through the first load balancer 3 or the second load balancer 4 for processing, and all data intended to be transmitted from the server 8 should be transmitted out from the packet filter 6 after first passing through the real server 7. Herein, the packet filter 6 usually functions in the form of a software program such as a firewall within the server 8. The functions of the packet filter 6, the first packet filter 9 and the second packet filter 10 are consistent, of which the detailed operation and connecting blocks will be described in the following paragraphs.

When the clients 1 and 2 provide the link service through the virtual IP Address of the first load balancer 3, the first load balancer 3 will receive the connection requests of the plurality of clients 1 and 2 through the first packet filter 9 and calculate the number of the received connection requests to determine whether it has exceeded the upper limit of processing. When the first load balancer 3 confirms the number of the received connection requests has exceeded the upper limit of load, the hash table will be edited according to the master code set in the first load balancer 3, and the second load balancer 4 will be set and activated to share in the load of the first load balancer 3.

Both of the first load balancer 3 and the second load balancer 4 select a real server 7 in the manner of load balance, and reset the target IP address (i.e. the virtual IP address of the first load balancer 3) to point to the IP address of the internal server 7 actually providing services. Meanwhile, the first load balancer 3 and the second load balancer 4 record this linkage in the hash table. When the real server 7 makes responses to the requests of the clients 1 and 2, it is necessary to pass through the load balancer (the first load balancer 3 or the second load balancer 4) the requests forwarded from via the packet filter 6, and then use the load balancer to change the source addresses (the IP addresses of the clients 1 and 2) and the source ports (the port numbers of the clients 1 and 2) to the virtual IP address and the corresponding port of the first load balancer 3, and directly send the responses to the clients 1 and 2. When the linkage ends or is overtimed, the first load balancer 3 will delete this linkage from the hash table. In this way, what the clients 1 and 2 see is only the service provided at the virtual IP address of the first load balancer 3. Herein, when the number of the connection requests received by the first load balancer 3 has not exceeded the upper limit of the load capacity of the first load balancer 3, the present situation is maintained, i.e. the second load balancer 4 only performs the function of data backup.

In addition, when the first load balancer 3 fails, the second load balancer 4 reselects the connection requests by editing the hash table, so as to continue the action of forwarding the connection requests of the clients 1 and 2. Herein, the hash table may be maintained through the first and the second load balancers 3, 4 as well as the server 8, so as to ensure the uniformity thereof.

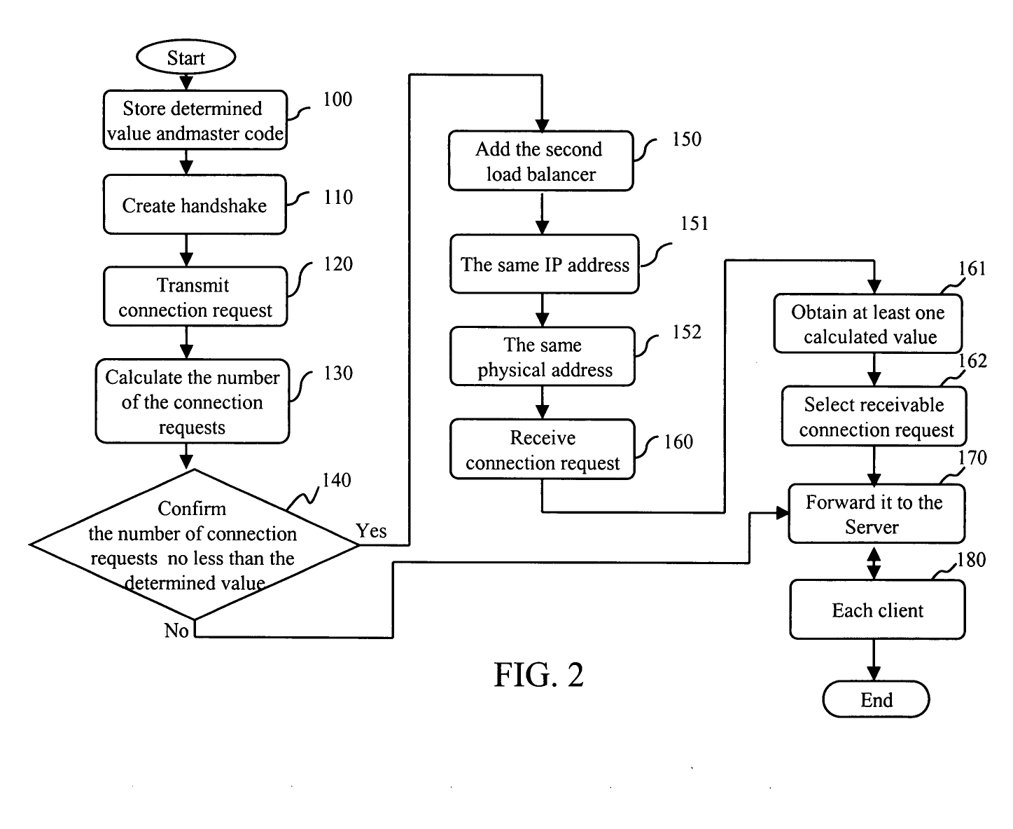

With reference to FIG. 2, it is a flow chart of the method for expanding data flow disclosed according to the present invention. The method is applied in a network system comprising at least one client 1, 2, at least two load balancers 3 and 4, and at least one server 8, in which the server comprises a packet filter 6 and a real server 7. The method comprises the following steps: first, the first load balancer 3 creates a determine value and a master code (Step 100); the server 8 carries out the three party handshake with each of the clients 1 and 2 through the first load balancer 3 (Step 110); each of the clients 1 and 2 transmits the connection request to the first load balancer 3 (Step 120), and that means the connection requests of the clients 1 and 2 are received through the first packet filter 9 of the first load balancer 3, with the content of the connection requests being a group of the IP addresses, port numbers and firewall marks of the clients 1 and 2. The first load balancer 3 calculates the number of the received connection requests (Step 130); the first load balancer 3 confirms that the number of the connection requests is not smaller than the determine value (Step 140), wherein when the first load balancer 3 confirms the number of the connection requests is smaller than the determine value, the first load balancer 3 directly forwards the connection requests to the server 8 (Step 170). Then the first load balancer 3 edits the hash table with the master code, so as to add the second load balancer 4 (Step 150), and that means in turn, the first load balancer sets the second load balancer 4 according to the hash table to make it have the same IP address (Step 151) and the same physical address of the network card (Step 152).

Then, the first load balancer 3 and the second load balancer 4 receive the connection requests (Step 160); i.e., the first load balancer 3 and the second load balancer 4 calculate the content of each of the connection requests with the hash algorithm, obtaining at least one calculated value (Step 161); and the first load balancer 3 and the second load balancer 4 associate each of the calculated values with the hash table so as to select the receivable connection requests (Step 162). The hash algorithm is stored in the hash table and involves the operations obeying the mathematical logic rules for obtaining at least one calculated value. The mathematical logic rules mentioned are a combination of addition, subtraction, multiplication and division.

Now take the content of one connection request for example. If the content of the connection request comprises the IP address 10.190.5.16 and the port number 5567, etc. of the client 1, 2, the process of the hash algorithm is as follows: adding the IP address 10.190.5.16 to the port number 5567 of the client 1, 2 to get the sum, i.e., 10+190+5+16+5567, with the sum of 5788; and then dividing 5788 by the module of 8 to get the quotient of 723 and the remainder of 4, which is the above-mentioned calculated value. Here, the module is obtained according to the hash table comparison.

Then, the first load balancers 3 and the second load balancer 4 forward each of the connection requests to the server 8 (Step 170). Finally, each of the clients 1 and 2 carries out data access to the server 8 (Step 180).

The present invention is characterized in that the first load balancer 3 can automatically confirm whether it is overloaded or not to edit the hash table, so as to activate the second load balancer 4 and forward the requests of the clients to the server, such that the clients will not wait for a long time due to the influence of the load balancer like before and thus the processing capacity of the load balancer is improved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for expanding data flow applied in a network system comprising at least one client, at least two load balancers and at least one server, comprising the following steps.
a first load balancer creates a determine value and a master code;
the server carries out the three party handshake with each of the clients through the first load balancer;
each of the clients transmits a connection request to the first load balancer;
the first load balancer calculates the number of the received connection requests;
the first load balancer confirms that the number of the connection requests is not smaller than the determine value;
the first load balancer edits a hash table through the master code in order to add a second load balancer;
the first load balancer and the second load balancer receive the connection requests;
the first load balancer and the second load balancer forward each of the connection requests to the server; and
each of the clients carries out data access to the server.

2. The method for expanding data flow of claim 1, wherein the step that the first load balancer edits a hash table through a master code in order to add a second load balancer comprises the following steps□
the first load balancer sets the second load balancer to have the same IP address according to the hash table; and
the first load balancer sets the second load balancer to have the same physical address of the network card according to the hash table.

3. The method for expanding data flow of claim 1, wherein the step that the first load balancer and the second load balancer receive the connection requests comprises the following steps:
the first load balancer and the second load balancer calculate the content of each of the connection requests with a hash algorithm to obtain at least one calculated value; and
the first load balancer and the second load balancer associate each of the calculated values with the hash table so as to select the receivable connection request.

4. The method for expanding data flow of claim 3, wherein the content of the connection request is the group of the IP address, port number and firewall mark of the client.

5. The method for expanding data flow of claim 3, wherein the hash algorithm is stored in the hash table.

6. The method for expanding data flow of claim 1, wherein when the first load balancer confirms that the number of connection requests is smaller than the determine value, the step that the first load balancer directly forwards each of the connection requests to the server is performed.

7. The method for expanding data flow of claim 1, wherein each of the servers comprises a physical server and a packet filter.

8. The method for expanding data flow of claim 1, wherein the step that each of the clients transmits a connection request to the first load balancer is received through a first packet filter of the first load balancer.
